(19) United States
(12) Patent Application Publication
(10) Pub. No.: US 2014/0325817 A1
(43) Pub. Date: Nov. 6, 2014

(54) BOOK JACKET METHODS AND DEVICES FOR ELECTRONIC READING SYSTEMS

(71) Applicant: LaZelma Nealy, Dallas, TX (US)

(72) Inventor: LaZelma Nealy, Dallas, TX (US)

(21) Appl. No.: 13/934,142

(22) Filed: Jul. 2, 2013

Related U.S. Application Data
(60) Provisional application No. 61/819,214, filed on May 3, 2013.

(51) Int. Cl. B42D 3/08

(52) U.S. Cl. CPC B42D 3/08; B42P 2261/00
USPC 29/428

(57) ABSTRACT

Methods for using a physical book jacket with an electronic book reader device can include a protective cover configured to couple the book jacket to the electronic book reader device. Several method embodiments include obtaining an electronic book and obtaining a physical book jacket that displays information regarding the electronic book.

### RELATED APPLICATION

This application claims the benefit of U.S. Provisional Patent Application No. 61/819,214, entitled HANDHELD ELECTRONIC BOOK READER DEVICE BOOK JACKET USE AND METHOD, and filed May 3, 2013, the entire contents of which are incorporated herein by reference.

### BACKGROUND

1. Field

Various embodiments disclosed herein relate to book jacket devices and methods. Certain embodiments relate to means for displaying information regarding electronic books, articles, and publications.

2. Description of Related Art

Hardback and paperback books sometimes include a book jacket, which is sometimes referred to as a dust jacket, dust wrapper, dust cover, book cover, or book sleeve. The book jacket can be made of paper and is sometimes detachable. The book jacket can be printed with information regarding the book.

### SUMMARY

Some embodiments for using a first physical book jacket with an electronic book reader device include coupling a protective cover to the reader device, obtaining a first electronic book, obtaining the first physical book jacket that displays information regarding the first electronic book, and coupling the first physical book jacket to at least a portion of the protective cover. Several embodiments include obtaining a second electronic book, obtaining a second physical book jacket that displays information regarding the second electronic book, and coupling the second physical book jacket to the portion of the protective cover.

Several embodiments for using a first physical book jacket with an electronic book reader device include selling a first electronic book to a first buyer, selling the first physical book jacket that displays information regarding the first electronic book to the first buyer, facilitating electronic delivery of the first electronic book to the first buyer, and facilitating physical delivery of the first physical book jacket to the first buyer.

Some embodiments for using a first physical book jacket with an electronic book reader device include manufacturing a protective cover configured to removably couple the first physical book jacket to the reader device and configured to enable replacing the first physical book jacket with a second physical book jacket. Several embodiments include creating instructions regarding coupling the protective cover to the reader device, creating instructions regarding coupling the first physical book jacket to the reader device, creating instructions regarding removing the first physical book jacket from the reader device, and creating instructions regarding coupling a second physical book jacket to the reader device. A physical book jacket can comprise a name of an author of an electronic book, a title of the electronic book, and artwork related to the electronic book.

### BRIEF DESCRIPTION OF THE DRAWINGS

These and other features, aspects, and advantages are described below with reference to the drawings, which are intended to illustrate, but not to limit the invention. In the drawings, like reference characters denote corresponding features consistently throughout similar embodiments.

FIGS. 1-3 illustrate various elements that can be present in several method embodiments.

FIG. 4 illustrates a perspective view of an electronic book reader device, according to one embodiment.

FIG. 5 illustrates a perspective view of the electronic book reader device from FIG. 4, where the display is covered by a protective cover, according to one embodiment.

FIG. 6 illustrates a perspective view of the electronic book reader device from FIG. 4 with a transparent sheet that creates a pocket on the exterior surface of a protective cover, according to one embodiment.

FIG. 7 illustrates a perspective view of the protective cover from FIG. 6, according to one embodiment.

FIG. 8 illustrates a book jacket coupled to the protective cover from FIG. 6, according to one embodiment.

FIG. 9 illustrates an embodiment of a book jacket and a protective cover that are configured to make the reader device from FIG. 4 look like a paperback book, according to one embodiment.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

The following patent is incorporated herein by reference: U.S. Pat. No. 4,341,401, entitled METHOD AND APPARATUS FOR COVERING BOOKS, and filed Feb. 11, 1980. The following patent is incorporated herein by reference: U.S. Pat. No. 4,715,619, entitled BOOK JACKET, and filed Jan. 13, 1986. The following patent application publication is incorporated herein by reference: U.S. Patent Application Publication No. US 2010/0149739 A1, entitled PROTECTIVE COVER FOR AN EREADER, and published Jun. 17, 2010.

As used herein, electronic books (“e-books”) include electronic articles, electronic periodicals, and electronic publications that a person can read via an electronic book reader device (“e-reader”). E-books are sometimes called digital books. People can download e-books from companies such as Amazon Inc. E-readers are mobile electronic devices designed to enable people to read e-books. Examples of e-readers include Kindle made by Amazon Inc., Nook made by Barnes & Noble Inc., iPad made by Apple Inc., and tablet computers.

Book jackets can help market and promote books. Book jackets can display useful information regarding books. People in the same room or in close proximity to a person reading a book can sometimes see the useful information, which can encourage the people to buy the book that the person is reading.

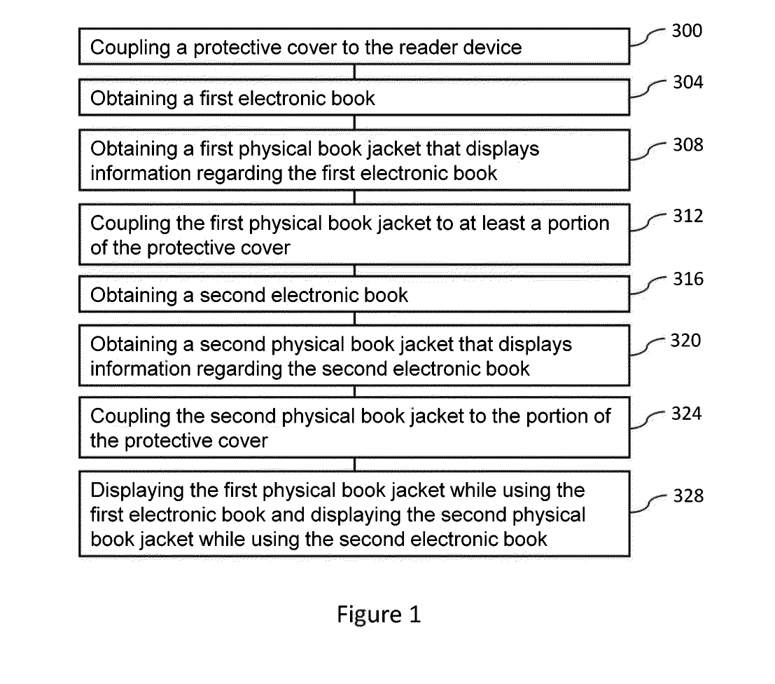

FIG. 1 illustrates various elements that can be present in several method embodiments for using a physical book jacket with an electronic book reader device. A physical book jacket is an object that someone can touch. Some physical book jackets are made from paper or thin plastic. Several embodiments use digital book jackets in the place of physical book jackets. Digital book jackets can be displayed on a display such as a light emitting diode (“LED”) display or a liquid-crystal display (“LCD”).

Step 300 can include coupling a protective cover to the reader device. In some embodiments, a protective cover is coupled to the reader device by attaching the back of the reader device to one panel of the protective cover and then closing a hinge of the protective cover to cover the display of the reader device. In some embodiments, the protective cover covers the display but does not cover the rest of the reader device. Protective covers can be made from many materials such as leather, plastic, and rubber.

Step 304 can include obtaining a first electronic book. Step 308 can include obtaining a first physical book jacket that displays information regarding the first electronic book. The information can include data regarding the book such as the author's name, the author's photo, biographical information regarding the author, book title, cover art, jacket copy, blurbs regarding the book, book length, and book contents. Step 312 can include coupling the first physical book jacket to at least a portion of the protective cover. In some embodiments, this coupling can include wrapping at least a portion of the book jacket around at least a portion of the protective cover. In several embodiments, this coupling can also or alternatively include sliding at least a portion of the book jacket into a pocket of the protective cover, where the pocket has a transparent or semi-transparent exterior surface that allows a person to see the book jacket inside the pocket.

Step 316 can include obtaining a second electronic book. Step 320 can include obtaining a second physical book jacket that displays information regarding the second electronic book. Step 324 can include coupling the second physical book jacket to the portion of the protective cover. Step 328 can include displaying the first physical book jacket while using the first electronic book and displaying the second physical book jacket while using the second electronic book. Displaying a book jacket can comprise positioning the book jacket such that a person can see at least a majority of the book jacket when the protective cover is open and/or closed. For example, many hardback books display their book jackets.

Some embodiments comprise obtaining a third electronic book, obtaining a third physical book jacket that displays information regarding the third electronic book, and inserting the third physical book jacket into the portion of the protective cover. Some embodiments include using a similar method with a fourth, fifth, and/or sixth electronic book.

Several embodiments include selling the first physical book jacket and the first electronic book to a buyer. Buyers can trade book jackets with electronic books. For example, a person might post an online advertisement for an electronic book and physical book jacket. The advertisement can offer to sell the electronic book in conjunction with the physical book jacket such that the buyer will receive both the electronic book and the physical book jacket. Book jackets can encourage people to buy more electronic books than they would if electronic books were sold without book jackets. The book jackets can have substantial value to collectors and avid readers.

In some cases, protective covers comprise a transparent sheet. Coupling the first physical book jacket to the portion of the protective cover can comprise placing the first physical book jacket under the transparent sheet such that at least a majority of the information regarding the first electronic book is visible. Information that the first physical book jacket displays can include a name of an author of the first electronic book, a title of the first electronic book, artwork related to the first electronic book, a photo of the author, biographical information regarding the author, and at least thirty words regarding contents of the first electronic book. In several embodiments, information that a book jacket displays can include at least 30 words and less than 500 words regarding contents of an electronic book; at least 50 words and less than 200 words regarding contents of an electronic book; or at least 80 words and less than 150 words regarding contents of an electronic book.

Many materials can be used to manufacture physical book jackets including paper, plastic, and fabric. In some embodiments, at least 70 percent of the physical book jacket consists of paper. In several embodiments, the physical book jacket is less than one millimeter thick; more than 0.01 mm thick and less than 0.3 mm thick; or more than 0.1 mm thick and less than 0.7 mm thick. In some embodiments, at least 70 percent of the first physical book jacket consists of plastic.

Several embodiments include offering to sell a physical book jacket (which can be made from paper) and an electronic book contemporaneously to a buyer or simultaneously to a buyer. Some embodiments include selling a physical book jacket and an electronic book in the same online shopping cart to the same buyer. In some cases, the sale of the physical book jacket to a buyer takes place within 10 seconds, 20 seconds, or 180 seconds of the sale of the electronic book to the buyer.

Method embodiments can also include facilitating physical delivery of the physical book jacket to the first buyer via a mail delivery service. Mail delivery services include FedEx Corporation, United Parcel Service of America Inc., the United States Postal Service, and shipping services in the United States and other countries.

Method embodiments can also include facilitating electronic delivery of an electronic book to a buyer via Internet or wireless communication. For example, a seller can enable a buyer to download the electronic book via the Internet. Amazon Inc. allows buyers to download electronic books. Wireless communication can also enable sellers to enable buyers to download electronic books. For example, electronic book data can be sent via BlueTooth, radio, and infrared communication systems.

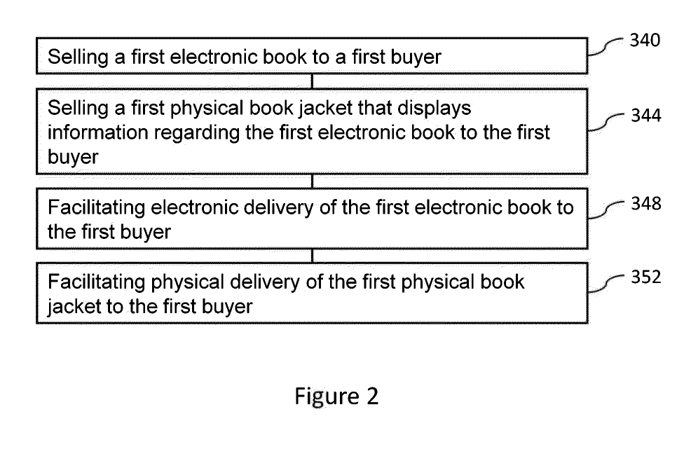

FIG. 2 illustrates various elements that can be present in several method embodiments for using a physical book jacket with an electronic book. Step 340 can include selling a first electronic book to a first buyer. The buyer can be located remotely from the seller. For example, the seller and buyer can communicate via the Internet. In some embodiments, the seller is located at least 1,000 meters from the buyer.

Step 344 can include selling a first physical book jacket that displays information regarding the first electronic book to the first buyer. Step 348 can include facilitating electronic delivery of the first electronic book to the first buyer. Facilitating electronic delivery of the first electronic book to the first buyer can comprise sending the first electronic book via Internet or wireless communication. Step 352 can include facilitating physical delivery of the first physical book jacket to the first buyer. Facilitating physical delivery of the first physical book jacket to the first buyer can include sending the first physical book jacket via a mail delivery service.

Facilitating electronic delivery and/or physical delivery can comprise requesting delivery and/or initiating delivery, and does not necessarily include actually delivering an item. For example, actually delivering an item may require steps performed by multiple parties, even though the seller alone can facilitate delivery by requesting delivery, initiating delivery, approving delivery, approving a delivery process, and/or authorizing delivery.

As mentioned previously, selling the first electronic book and selling the first physical book jacket can occur contemporaneously or simultaneously. The sale of an electronic book and a physical book jacket can be tied together such that both items are represented by one price or the items are purchased as part of a sales package or sales bundle. Several embodiments include offering to sell the first electronic book with the first physical book jacket.

Some embodiments include providing a protective cover for the reader device, providing instructions regarding placing the first physical book jacket under a transparent portion of the protective cover, and/or providing instructions regarding replacing the first physical book jacket with a second physical book jacket that displays information regarding a second electronic book. For example, a reader can display the first book jacket when reading the first electronic book and can display the second book jacket when reading the second electronic book. Thus, the book jacket that is displayed can be correlated with the book being read.

Some embodiments include selling the first electronic book and the first physical book jacket to a second buyer. For example, resale of the electronic book can include resale of the associated book jacket.

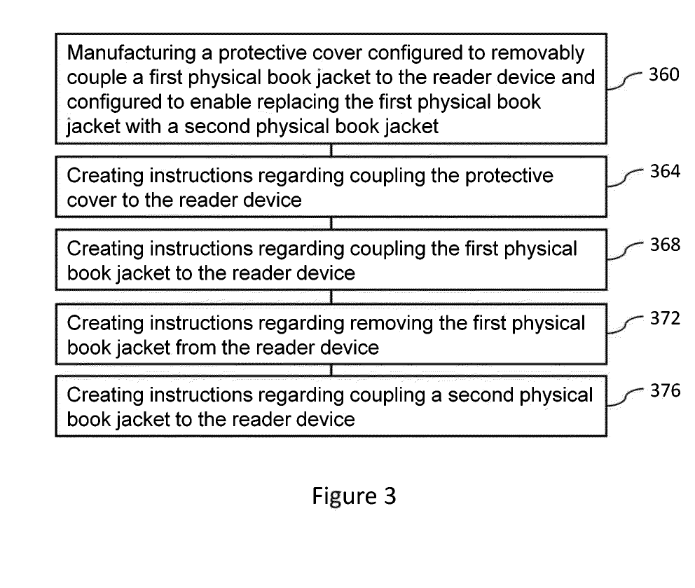

FIG. 3 illustrates various elements that can be present in several method embodiments for using a physical book jacket with an electronic book reader device. The method can include several manufacturing steps. Step 360 can include manufacturing a protective cover configured to removably couple the first physical book jacket to the reader device and configured to enable replacing the first physical book jacket with a second physical book jacket.

Step 364 can include creating instructions regarding coupling the protective cover to the reader device. Coupling the protective cover to the reader device can include attaching the protective cover to the reader device.

Step 368 can include creating instructions regarding coupling the first physical book jacket to the reader device. Coupling the book cover to the reader device can include attaching the book cover to the reader device. Coupling the book cover to the reader device can include sliding the book cover into an exterior pocket of the reader device such that the book cover is visible when the protective cover is in a closed position.

Step 372 can include creating instructions regarding removing the first physical book jacket from the reader device. Removing the book jacket from the reader device can include detaching the book jacket from the reader device. Removing the book jacket from the reader device can include sliding the book jacket out of the exterior pocket.

Step 376 can include creating instructions regarding coupling a second physical book jacket to the reader device. Coupling the book cover to the reader device can include attaching the book cover to the reader device. Coupling the book cover to the reader device can include sliding the book cover into an exterior pocket of the reader device such that the book cover is visible when the protective cover is in a closed position. The second book jacket can replace the first book jacket or be placed over the first book jacket. The physical book jackets can include a name of an author of the electronic book, a title of the electronic book, and artwork related to the electronic book.

Some embodiments include creating instructions regarding displaying the first physical book jacket while using the first electronic book and displaying the second physical book jacket while using the second electronic book.

In several embodiments, the reader device comprises a display and the protective cover is configured to cover at least the display of the reader device. Manufacturing the protective cover can comprise manufacturing a transparent sheet and coupling the transparent sheet to an at least partially rigid panel. Methods can also include creating instructions regarding placing the first physical book jacket between the transparent sheet and the at least partially rigid panel.

Some book jackets are detachable outer covers, although some book jackets are not detachable. Some book jackets have folded flaps, although some book jackets do not have folded flaps. Some book jackets are fragile, while other book jackets are not fragile. Book jackets can be printed with useful text and pictures.

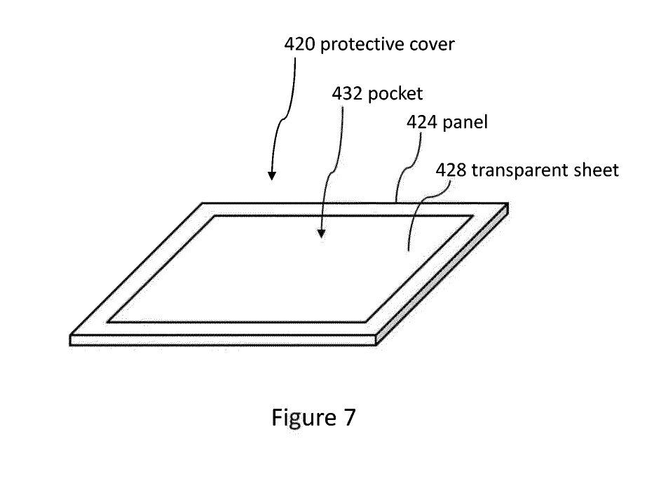

FIG. 7 of U.S. Patent Application Publication No. US 2010/0149739 A1 illustrates one example of a protective cover 100, although many other shapes and materials can be used to manufacture protective covers. Referring now to FIGS. 1 and 2 of U.S. Patent Application Publication No. US 2010/0149739 A1, a protective cover 100 for an electronic book reader device can include a front cover 102 and a rear cover 104. The front cover 102 and rear cover 104 can each have interior surfaces 102a, 104a and exterior surfaces 102b, 104b. In some embodiments, book jackets cover at least a portion of the exterior surfaces 102b, 104b and/or majorities of the exterior surfaces 102b, 104b. In some embodiments, book jackets cover the exterior surface 102b or the exterior surface 104b, but do not cover both exterior surfaces 102b, 104b.

FIG. 1 of U.S. Pat. No. 4,715,619 illustrates one example of a physical book jacket, although many other shapes and materials can be used to manufacture book jackets.

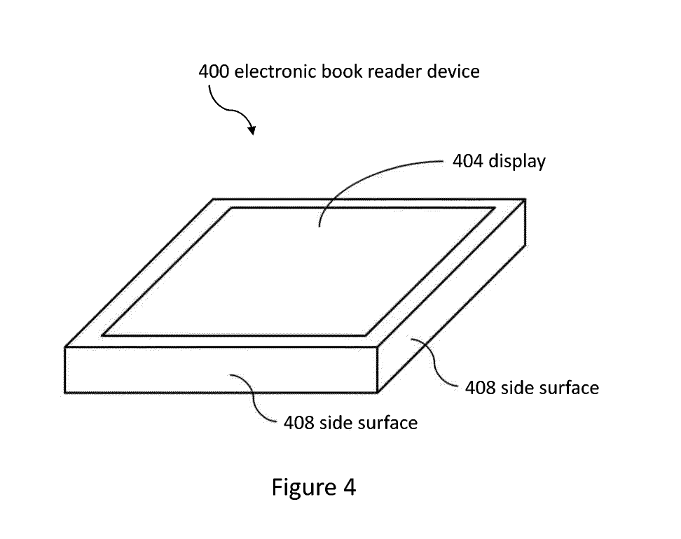

FIG. 4 illustrates a perspective view of an electronic book reader device 400, according to one embodiment. The reader device 400 can include a display 404 configured to show text, pictures, and/or videos. For example, a reader can view books, articles, publications, and movies on the display 404. The reader device 400 includes side surfaces 408.

Some protective covers encase the entire reader device 400, but other protective covers only cover a portion of the reader device 400. For example, some protective covers protect the display 404, but do not protect or cover all of the side surfaces 408 or the back of the reader device 400 (not shown). The back of the reader device 400 is the side opposite the display 404.

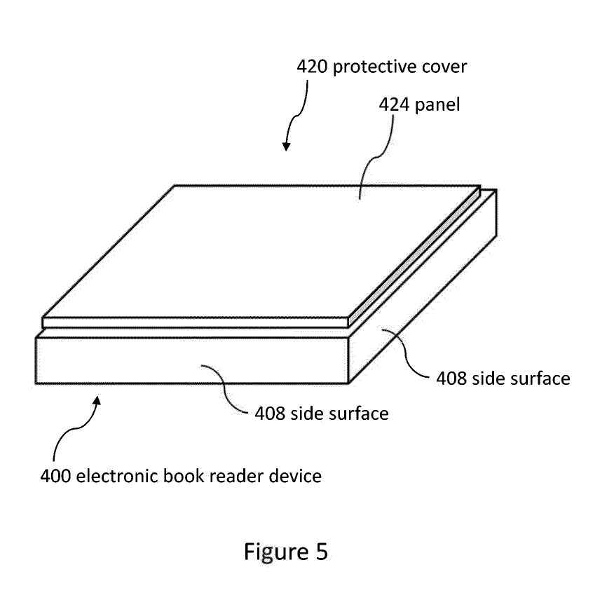

FIG. 5 illustrates a perspective view of the electronic book reader device 400 from FIG. 4, where the display is covered by a protective cover 420, according to one embodiment. The protective cover 420 can include a panel 424, which can be an at least partially rigid panel made from plastic or cardboard. In some embodiments, the panel 424 is less than 1 centimeter thick.

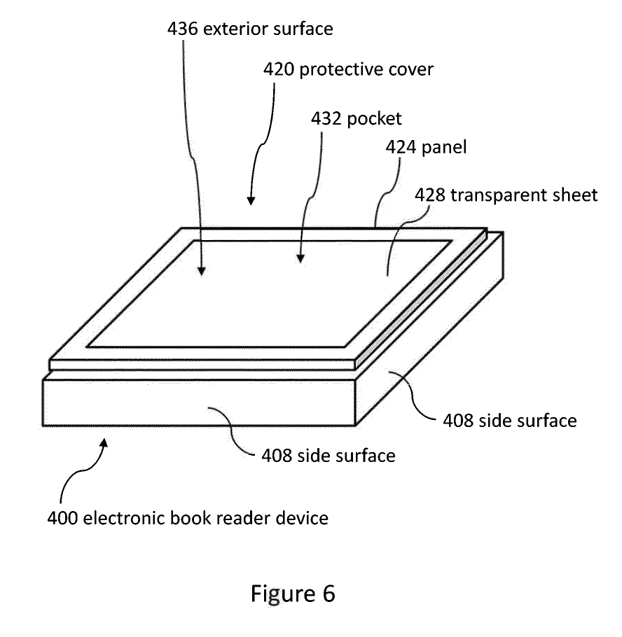

FIG. 6 illustrates a perspective view of the electronic book reader device 400 with a transparent sheet 428 that creates a pocket 432 on the exterior surface 436 of the protective cover 420. A person can slide or place a book jacket between the transparent sheet 428 and the panel 424. FIG. 7 illustrates a perspective view of the protective cover 420.

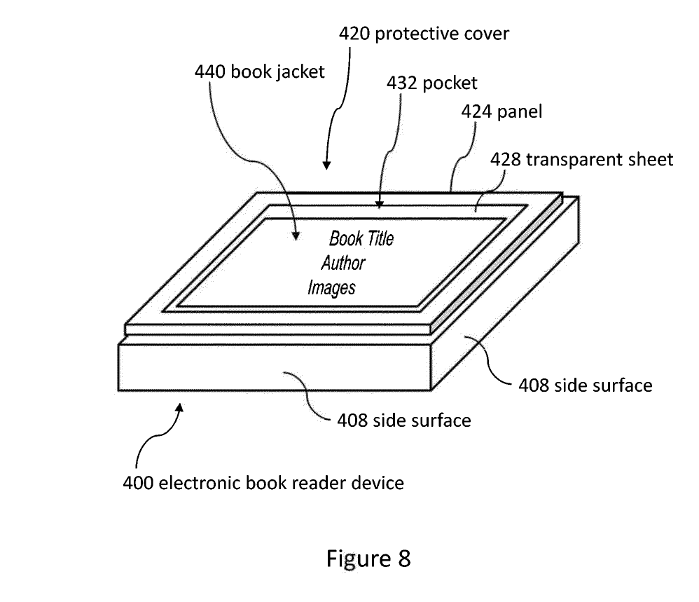

FIG. 8 illustrates a book jacket 440 coupled to the protective cover 420, located under the transparent sheet 428, and located inside the pocket 432. The book jacket 440 displays information regarding an electronic book, which can be the electronic book that a reader is in the middle of reading, even if the reader is not currently reading at the moment.

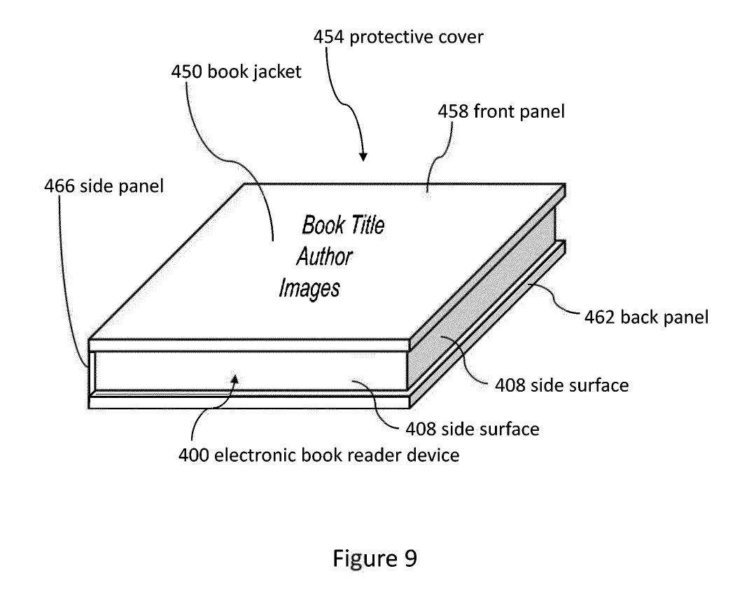

FIG. 9 illustrates an embodiment of a physical book jacket 450 and a protective cover 454 that are configured to make the reader device 400 look like a paperback book. The protective cover 454 comprises a front panel 458 and a back panel 462, which can be coupled via a side panel 466. In several embodiments, the book jacket 450 wraps around the front and the back of the protective cover 454.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods and processes described herein are also not limited to any particular sequence, and the blocks or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

I claim:

1. A method for using a first physical book jacket with an electronic book reader device, the method comprising:
coupling a protective cover to the reader device;
obtaining a first electronic book;
obtaining the first physical book jacket that displays information regarding the first electronic book;
coupling the first physical book jacket to at least a portion of the protective cover;
obtaining a second electronic book;
obtaining a second physical book jacket that displays information regarding the second electronic book; and
coupling the second physical book jacket to the portion of the protective cover.

2. The method of claim 1, further comprising displaying the first physical book jacket while using the first electronic book and displaying the second physical book jacket while using the second electronic book.

3. The method of claim 1, further comprising obtaining a third electronic book, obtaining a third physical book jacket that displays information regarding the third electronic book, and inserting the third physical book jacket into the portion of the protective cover.

4. The method of claim 1, further comprising selling the first physical book jacket and the first electronic book to a buyer.

5. The method of claim 1, wherein the first physical book jacket and the protective cover are configured to make the reader device look like a paperback book.

6. The method of claim 1, wherein the protective cover comprises a transparent sheet and coupling the first physical book jacket to the portion of the protective cover comprises placing the first physical book jacket under the transparent sheet such that at least a majority of the information regarding the first electronic book is visible.

7. The method of claim 6, wherein the information that the first physical book jacket displays comprises a name of an author of the first electronic book, a title of the first electronic book, and artwork related to the first electronic book.

8. The method of claim 7, wherein the information that the first physical book jacket displays comprises a photo of the author, biographical information regarding the author, and at least thirty words regarding contents of the first electronic book.

9. The method of claim 7, wherein at least seventy percent of the first physical book jacket consists of paper and the first physical book jacket is less than one millimeter thick.

10. The method of claim 7, wherein at least seventy percent of the first physical book jacket consists of plastic and the first physical book jacket is less than one millimeter thick.

11. A method for using a first physical book jacket with an electronic book, the method comprising:
selling a first electronic book to a first buyer;
selling the first physical book jacket that displays information regarding the first electronic book to the first buyer;
facilitating electronic delivery of the first electronic book to the first buyer; and
facilitating physical delivery of the first physical book jacket to the first buyer.

12. The method of claim 11, wherein facilitating electronic delivery of the first electronic book to the first buyer comprises sending the first electronic book via Internet or wireless communication.

13. The method of claim 12, wherein facilitating physical delivery of the first physical book jacket to the first buyer comprises sending the first physical book jacket via a mail delivery service.

14. The method of claim 11, wherein selling the first electronic book and selling the first physical book jacket occur contemporaneously or simultaneously.

15. The method of claim 11, further comprising offering to sell the first electronic book with the first physical book jacket.

16. The method of claim 11, further comprising providing a protective cover for an electronic book reader device, providing instructions regarding placing the first physical book jacket under a transparent portion of the protective cover, and providing instructions regarding replacing the first physical book jacket with a second physical book jacket that displays information regarding a second electronic book.

17. The method of claim 11, further comprising selling the first electronic book and the first physical book jacket to a second buyer.

18. A method for using a first physical book jacket with an electronic book reader device, the method comprising:
manufacturing a protective cover configured to removably couple the first physical book jacket to the reader device and configured to enable replacing the first physical book jacket with a second physical book jacket;
creating instructions regarding coupling the protective cover to the reader device;
creating instructions regarding coupling the first physical book jacket to the reader device;
creating instructions regarding removing the first physical book jacket from the reader device; and
creating instructions regarding coupling a second physical book jacket to the reader device, wherein the first physical book jacket comprises a name of an author of a first electronic book, a title of the first electronic book, and artwork related to the first electronic book, and the second physical book jacket comprises a name of an author of a second electronic book, a title of the second electronic book, and artwork related to the second electronic book.

19. The method of claim 18, further comprising creating instructions regarding displaying the first physical book jacket while using the first electronic book and displaying the second physical book jacket while using the second electronic book.

20. The method of claim 19, wherein the reader device comprises a display, the protective cover is configured to cover at least the display of the reader device, manufacturing the protective cover comprises manufacturing a transparent sheet and coupling the transparent sheet to an at least partially rigid panel, and the method further comprises creating instructions regarding placing the first physical book jacket between the transparent sheet and the panel.
